(19) United States
(12) Patent Application Publication
(10) Pub. No.: US 2018/0276620 A1
(43) Pub. Date: Sep. 27, 2018

(54) COMPUTERIZED SYSTEM FOR RETIREMENT

(71) Applicant: Bao Tran, (US)

(72) Inventor: Christopher Daniels, Springfield, IL (US)

(21) Appl. No.: 15/467,956

(22) Filed: Mar. 23, 2017

(51) Int. Cl. G06Q 10/10; G06F 17/11; G06Q 20/32; G06K 7/10; G06Q 20/20

(52) U.S. Cl. CPC G06Q 10/1057; G06F 17/11; G06Q 50/01; G06K 7/10554; G06Q 20/202; G06Q 20/3224

(57) ABSTRACT

A system to manage a plan includes a module to assign one or more tokens to an eligible transaction based on predetermined participant activity satisfying a sponsor's requirement; a module to receive information on a participant engagement with the eligible transaction; a module to assign the one or more tokens to the participant based on the eligible transaction; a module to track and store all tokens received by the participant; a module to redeem token values to the participant upon completion of a predefined period; and a graphical interface for information retrieval, using a computing device, to communicate tokens receive for each eligible transaction and a current or projected token accumulation at the end of the predefined period.

### FIELD OF THE INVENTION

The present invention is in the field of retirement systems and plans.

### BACKGROUND OF INVENTION

Presently, half of all people in America have no retirement assets and no plan for accumulating retirement assets. For those that have a retirement account, most are severely underfunded. Everyone has heard the terrible stories of people who retire into poverty because they have limited assets and no income and therefore become a burden on their families and on society. Roughly ten percent of a senior citizens now retire into dire poverty. That percentage of senior poverty is projected to grow to over 35% within twenty years. The country is facing a demographic great-depression.

The retirement crisis that gets worse with each passing day. Many people look to the government for retirement security. But the government is unable to provide solutions due to its own budgetary problems and political gridlock. Social security is projected to run a deficit within ten years.

With fewer employer-sponsored pension plans, people are left to fend for themselves through self-directed retirement plans like IRAs and 401(k)s. However, most people do not have the knowledge, the discipline or the tools needed to succeed at retirement planning.

### SUMMARY

A system to manage a plan includes a module to assign one or more tokens to an eligible transaction based on predetermined participant activity satisfying a sponsor's requirement; a module to receive information on a participant engagement with the eligible transaction; a module to assign the one or more tokens to the participant based on the eligible transaction; a module to track and store all tokens received by the participant; a module to redeem token values to the participant upon completion of a predefined period; and a graphical interface for information retrieval, using a computing device, to communicate tokens receive for each eligible transaction and a current or projected token accumulation at the end of the predefined period.

Advantages of the system may include one or more of the following. The system provides an automated system for retirement plans that do not require users to have the knowledge, the discipline or the tools needed to succeed at retirement planning. The system can help millions of people to accumulate value toward retirement and to supplement other resources.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 shows an exemplary method for provisioning retirement planning.

FIG. 2 shows an exemplary computer for processing retirement planning.

FIG. 3 shows an exemplary system for retirement planning.

FIG. 4A shows an exemplary mobile transaction capture system, while FIG. 4B shows an exemplary watch based transaction capture system.

FIG. 5 shows an exemplary computer to handle a retirement plan.

### DESCRIPTION

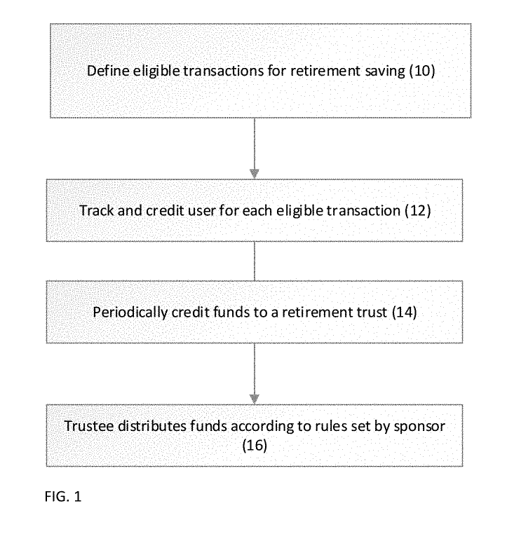

Referring now to the drawings in which like numerals represent the same or similar elements and initially to FIG. 1, a method is disclosed for supporting retirement that applies a computer system which processes eligible transactions according to a process that assigns a token representing value to each participant, and the value may be redeemed at a future date for use during the participant's retirement. In one exemplary embodiment shown in FIG. 1, the system is used by a sponsor offering a range of online services, each of which involves participant interaction with the system to transact as well as to input and to retrieve information.

In view of the exemplary systems shown and described below, methodologies that may be implemented in accordance with the embodiments will be better appreciated with reference to the flow chart of FIG. 1. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

In the method, a retirement plan sponsor defines on-line eligible transactions for retirement saving (10) to form an algorithm by which the sponsor may customize the computerized system to assign varing values to inputs and thereby impact the ultimate distribution of value. The system tracks on-line activities and credits participant for each eligible transaction (12). Periodically the system credit tokens representing value, objects representing value, or funds to a retirement trust (14). When the participant reaches a retirement age, the system allows a Trustee to distribute funds according to rules set by the sponsor (16).

The embodiments of FIG. 1 may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

To simplify for the purpose of illustration, the sponsor defines eligible transactions to include two exemplary online services: an online music store and an online internet search service. Specifically, every song that is purchased represents one eligible transaction and every search done represents an eligible transaction. A song purchase may be defined to have twice the value of a search. For each of attributing value and storing value, the processor may assign relative values to each eligible transaction: the song may be assigned 2 points and a search 1 point. Everyday millions of participants may conduct eligible transactions through one or more interfaces provided by the sponsor. The system processes the transactions and then stores data so that each participant accumulates a percentage of a total set of eligible transactions.

A sponsor input is used to set the type and amount of rewards sent. The rewards can be specified as funds or tokens or objects of value. The sponsor input received from a vendor can include information regarding how rewards should vary between times of day or year and between vendor locations, between participants having different characteristics, and based on the number of participants involved, and what circumstances trigger rewards to be sent. For example, the sponsor may want to contribute retirement funds to the participant if he or she exercises a certain amount per day. In this embodiment, a smart watch or a smart phone can be used to track the participant exercise activities, and upon completion of the exercise, the sponsor (such as an employer) can credit a predetermined amount to the participant's retirement account.

Individual participant interactions relating to an eligible transaction are tracked to facilitate in determining proper eligible transaction parameters. These parameters can include, but are not limited to, monetary value, location, frequency, and/or target audience of an eligible transaction. The interaction information can be utilized by an eligible transaction system to automatically adjust eligible transaction parameters and/or utilized by a sponsor to augment adjustments to their eligible transaction campaign. The eligible transaction interactions can be tracked on-line and/or off-line to allow client-side and/or server-side tracking configurations and mechanisms.

The accumulated monetary value can be held in a trust or other similar legally separate entity. The value per participant fluctuates based on the number of the participant's eligible transactions, the value assigned by sponsor to each eligible transaction conducted by participants, the amount of total activity of all participants and the gain or loss of value of trust assets prior to participant's ability to receive/redeem value.

The participant's portion of value is represented by points received for each transaction. In one exemplary system, the value (or number of tokens) is determined as follows:

TVu={Σ[Nu(VAu)]/Σ[Na(VAa)]}*AT
Where, TVu is Total Value to a participant
   Nu is number of the participant's eligible transactions
   VAu is Value Assigned to each eligible participant transaction (average)
   Na is Number of transactions by all participants
   VAa is Value Assigned to all eligible transactions
   A is Total Value of assets in trust

Dividing the Sums yields a percentage and the resulting percentage is then applied to Total Assets, yielding the amount of total value.

The system may be modified to project value at redemption by adding a projected relative growth factor and/or a projection of total trust assets and/or projection of relative assignment of tokens.

If redemption is to occur annual over many years or monthly over many months, the TVu can be divided by the total number of periodic payments resulting in the amount to be paid in the current period (understanding that each period the amount available can change based on eligible transactions, assets individual relative to total and number of remaining periods.

The fund assets are held in a trust or similar entity. In another embodiment, fund distributions are variable and not redeemable until a starting redemption date as determined by the sponsor. The assets are invested as retirement funds and funds may grow on a tax-deferred basis.

In one embodiment, the eligible transaction interaction tracking and crediting process can capture online interactions including, but not limited to e-mail, and/or shopping, and/or search and/or social network usage.

In another embodiment, the eligible transaction interaction tracking and crediting process can capture purchase of eligible items or transactions at a point of sale. The participant's presence at a point of sale during a transaction can be detected with a proximity detector. The proximity detector communicates with the participant's mobile device and detects that the participant is registered with a loyalty-reward system that funds in part the participant's retirement account.

Alternatively, the participant's presence at a point of sale during a transaction can be detected by reading information from a magnetic strip or other programmed card or bar-code, or from a keypad or other manual input. In one embodiment, the participant can swipe a mobile device and/or a smart watch with NFC to an NFC reader at the point of sale. The module utilizes an eligible transaction participant-interaction component that can store information relating to the transaction comprises transaction amount, products or services purchased, vendor, or location of transaction.

The module can capture additional information relating to the transaction such as stored transaction information from the participant's mobile device.

The module can also capture information from a smart watch located on a wrist band that shows the participant his or her daily exercise plan, notifies the participant accordingly and records the participant's performance based upon completion of those tasks. It also in one presently preferred embodiment monitors personal attributes of the participant such as the participant's calories, walking steps, location and time elapsed on certain tasks and the performance quality of the task using in a preferred embodiment features comprised of Near Field Communication connector or Bluetooth connector, a visible screen, and a motion detector such as a triple axis accelerometer. The smart watch provides an intuitive and participant-friendly interface for interconnecting participant's daily activities with computing devices, which include a smart phone.

The additional information can include information regarding the one or more people known by the participant, wherein electronically initiating the sending of rewards to the one or more people known by the participant comprises using the additional information regarding the one or more people known by the participant to select which of the one or more people to send the rewards to, or what rewards to send to the one or more people.

The system can capture a picture or sample audio recording at a point of sale to provide evidence that the participant engaged in a transaction.

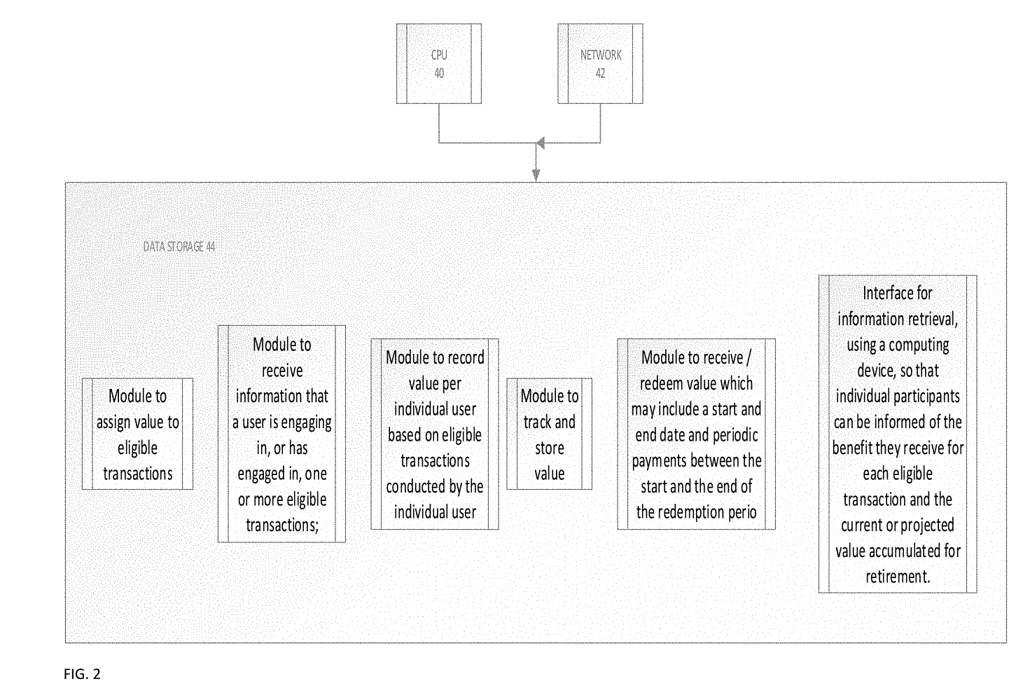

In another embodiment, the eligible transaction interaction tracking and crediting module shown in FIG. 2 utilizes an eligible transaction participant-interaction component that receives eligible transaction interaction information and provides participant-specific interaction information. The eligible transaction interaction information can include, but is not limited to, specific participant eligible transaction interactions such as selections (e.g., clicking on an eligible transaction, etc.) and/or conversions (i.e., purchases based on an eligible transaction) and the like. The interactions do not include strictly simple impressions without having additional participant involvement. Typically, the information includes a form of participant identification that can be utilized to track a particular participant. This can include, for example, a globally unique identifier (GUID) and the like. The eligible transaction participant-interaction component employs the eligible transaction interaction information to track individual participants and associate their interactions with specific eligible transactions to provide the participant-specific interaction information.

If unique participant IDs are available, a particular participant's interactions can be tracked regardless of where the participant is when he interacts with an eligible transaction. Thus, as long as the ID can be determined, a participant can be tracked while using different computing devices and/or in different locations and the like. The eligible transaction participant-interaction component can receive the eligible transaction interaction information in real-time and/or in a delayed manner. Some instances provided herein can track a participant's eligible transaction interactions off-line and then provide them to the eligible transaction participant-interaction component when a participant goes on-line again.

The participant-specific interaction information includes, but is not limited to, specific eligible transaction information such as location, size of the eligible transaction, time of day, and/or targeting data and the like along with participant interaction information for that specific eligible transaction. The participant-specific interaction information can then be utilized by an eligible transaction system, for example, to automatically adjust eligible transaction parameters (e.g., removal of eligible transaction, replacement of eligible transaction, extended duration, more frequent impressions, etc.) and/or by a sponsor to allow them to adjust their eligible transaction campaign and the like. The eligible transaction interaction information can be captured via direct input at a localized point of origin (e.g., input gathered at a participant's computing device as they surf the web, etc.) and/or from a remote location to the point of origin (e.g., data gathered over the Internet, etc.).

Because each client tracking component(s) can independently track a participant's eligible transaction interactions, it is not necessary for the client tracking component(s) to be in constant communication with the centralized tracking component. Thus, interaction information can be tracked off-line and sent to the centralized tracking component when client-server communications are re-established. For example, a participant can download a series of websites for off-line viewing. As the participant interacts with eligible transactions found on the websites, this information is tracked utilizing the client tracking component(s).

When the participant logs back into the Internet (or other communication means), the client tracking component(s) can upload tracking information to the centralized tracking component. By employing a centralized tracking component, a specific participant can be tracked regardless of which computing device they are using when interacting with eligible transactions. So, a participant can be tracked while using their mobile device, laptop, home desktop, and/or work computer and the like. The centralized tracking component processes the tracking information and provides composite participant-specific interaction information for utilization with eligible transaction systems and/or for dissemination to sponsors and the like.

Because on-line and off-line electronic eligible transaction is growing and is becoming more important as people spend more time using computers/software, the instances provided herein are extremely valuable to eligible transaction systems and sponsors as services and software can be marketed as eligible transactions that fund the participant's retirement program. By utilizing these instances, the value of eligible transaction systems to sponsors is increased substantially by allowing them to target eligible transactions to customers. Examples of eligible transactions include graphical and text eligible transactions on web pages and text eligible transactions on search results pages and the like and the types of media include, but are not limited to, video eligible transaction, paid-search eligible transactions, graphical eligible transactions, contextual eligible transactions, and/or animated eligible transactions and the like.

To determine these types of information, instances provided herein can include a tracking component and/or a display component. There are a variety of potential implementations for a tracking component. For instance, the information can be stored on a server and/or on a client. In one implementation using a client, a participant is given a unique identifier (GUID) which is stored on their computer. This GUID is accessed by a server when an eligible transaction is shown or clicked by a consumer, and this information is then logged in a cookie on the client. In a system in which participants are occasionally off-line the logging can either be done on the client and/or selection information can be uploaded to a server when the off-line system connects to the network/internet.

The sponsor periodically contributes funds to a trust which holds the funds in a custody account at a bank or other regulated financial institution. The trust assets are professionally managed by a registered investment advisor.

A trustee distributes funds according to rules established by the sponsor. At a particular start date, for example, on the participant's 68^{th} birthday, the participant can receive/redeem an amount each month or quarter or year based on their relative percentage of all value. A participant that has conducted 10,000 eligible transactions over the years will redeem for more value than a participant that has conducted fewer eligible transactions. Also, the nature of the transactions plays a role in value. Two participants that each conducted 10,000 eligible transaction but one participant conducted only music purchases and the other only searches. Due to the relative value of those transactions, the participants that purchased music will be entitled to twice the funds as the participant that conducted only searches.

FIG. 2 shows an exemplary computer for processing retirement planning. The system includes a module to assign one or more tokens to an eligible transaction based on predetermined participant activity satisfying a sponsor's requirement; a module to receive information on a participant engagement with the eligible transaction; a module to assign the one or more tokens to the participant based on the eligible transaction; a module to track and store all tokens received by the participant; a module to redeem token values to the participant upon completion of a predefined period; and a graphical interface for information retrieval, using a computing device, to communicate tokens receive for each eligible transaction and a current or projected token accumulation at the end of the predefined period.

The types of plans encompassed by the system include both ERISA-qualified retirement plans (ERISA is defined as the “Employee Retirement Income Security Act, adopted by the U.S. Congress in 1974”) and arrangements that are outside the scope of ERISA. ERISA-qualified retirement plans made available, currently or in the future, by employers for the benefit of employees and ERISA self-directed plans, which are given preferential tax treatment under the Internal Revenue Code (“IRC”), such as Profit Sharing Plans, Money Purchase Plans, 401(k) Plans, 457 Plans, 403(b) Plans, Cash Balance Plans and Supplemental Executive Retirement Plans. And further includes, -self-directed retirement plans known as Individual Retirement Accounts (IRAs), In addition, non-ERISA based arrangements are an alternative embodiments to the extent they provide comparable benefits. The computer includes a processor 40 coupled to the Internet via a computer network subsystem 42. The processor 40 accesses data and software modules in a data storage device 44. The data storage 44 includes one or more of the following modules:

Module to assign value to eligible transactions based on a predetermined method;

Module to receive information that a participant is engaging in, or has engaged in, one or more eligible transactions;

Module to record value per individual participant based on eligible transactions conducted by the individual participant;

Module to track and store value;

Module to receive/redeem value which may include a start and end date and periodic payments between the start and the end of the redemption period;

Interface for information retrieval, using a computing device, so that individual participants can be informed of the benefit they receive for each eligible transaction and the current or projected value accumulated for retirement.

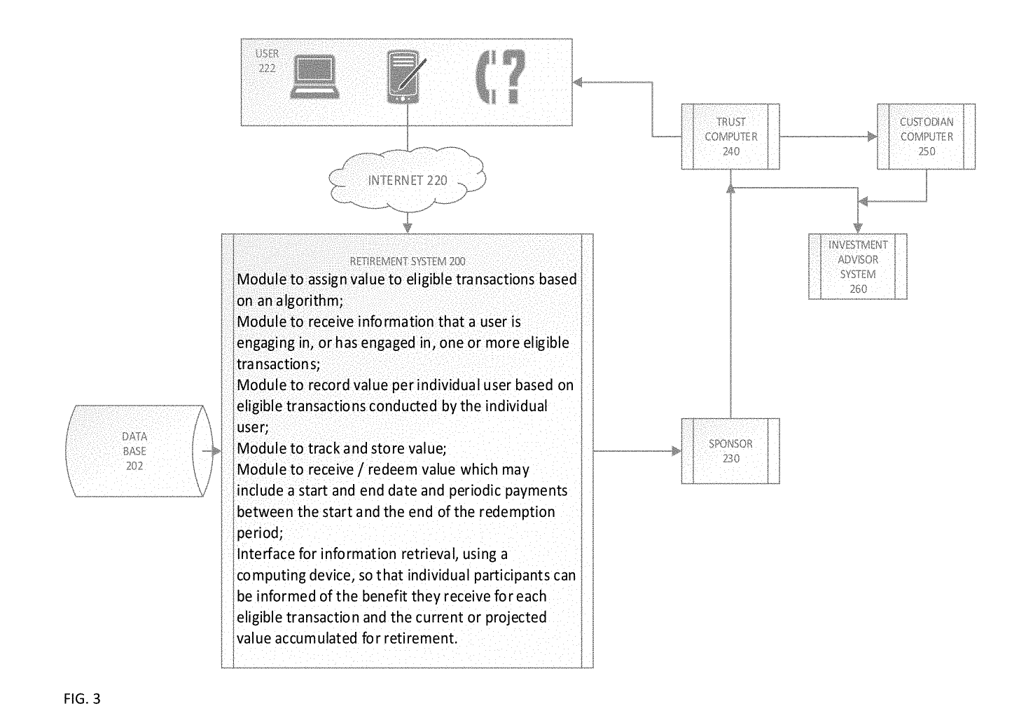

FIG. 3 is a block diagram showing a system in which participants input data and receive information output from a computer processor through various electronic devices that connect with an interface designed for this exchange. Further that the computer processor that is programmed to apply a set of system rules forming an algorithm that governs the system and wherein the processor is connected with a data storage unit that holds a database of participant information and system rules for retrieval when necessary.

The system of FIG. 3 includes a retirement system 200 that stores data in a database 202. The system 200 communicates with a sponsor computer 230, which communicates with a trust computer 240 which in turn communicates with a custodian computer 250. The trust computer 240 and sponsor computer 230 also communicate with an investment advisor system 260.

The retirement computer system 200 communicates with the participant 222 over the internet 220 through various channels including a desktop computer, a mobile phone, a tablet, or voice communication over a telephone or POTS network.

In one embodiment, the system includes modules that performs the following:
(a) assigning value (which may be absolute or relative) to eligible transactions based on an algorithm;
(b) receiving information that a participant is engaging in, or has engaged in, one or more eligible transactions where such data is an input to the computerized system;

A module is used to record value per individual participant based on eligible transactions conducted by the individual participant; and a system is used to track and store value. Another module is used to receive/redeem value which may include a start and end date and periodic payments between the start and the end of the redemption period. An interface is provided for information retrieval, using a computing device, so that individual participants can be informed of the benefit they receive for each eligible transaction and the current or projected value accumulated for retirement.

A list of eligible transactions is provided to participants, wherein the transactions may be in the form of participant payment in cash for goods or services or take the form of participant conducting certain activities.

In the preferred embodiment—the points assigned by the retirement system are not securities and/or federal securities regulators have decided or will agree in writing that they will not take enforcement action against the sponsor of such a retirement system even if some future interpretation by regulators may determine that the points are securities.

In one embodiment, the funds in trust are managed or advised by a registered investment advisor, which may or may not be affiliated with the sponsor of the system. Participants can access information through one or more computer system interfaces, available online or on a mobile device, that reports to the individual participant the amount they may receive now or at the time of redemption based on a set of assumptions on usage and asset growth.

In another embodiment, the sponsor or a third-party commits a portion of its gross revenue or net revenue to the trust.

Upon joining, the process receives and stores registration information from the participant.

The process includes electronically initiating the sending of data on accumulated value comprises sending information via text message, email, phone alert, app notification, or network posting or some other output decide that is in common use by individual consumers. The system can determine contact information comprises accessing the participant registration information. Alternatively, determining contact information can be done by accessing the participant's account on a social networking website.

The system can display a participant interface to a sponsor or an affiliate of sponsor or a sponsor-approved vendor, wherein the participant interface is configured for a vendor to input rules governing value provided, and receiving through the interface vendor-transmitted rules governing value provided.

The system tracks value received by each person that engages in eligible transactions. Upon participant request or satisfaction of one or more predetermined criteria, the system can send rewards to the participant.

The interactions for an eligible transaction can be tracked from a server-side and/or a client-side tracking mechanism. The interactions include user involvement with eligible transaction beyond merely witnessing and/or possible exposure to an eligible transaction. Thus, tracking information can be stored locally and sent to a centralized server mechanism (e.g., for storage/use on a server) when convenient and/or when communications are permitted between client and server. Raw interaction information can also be sent substantially real-time to a server mechanism for tracking purposes as well. The tracked user interactions with an eligible transaction can be employed to directly and/or indirectly influence parameters associated with placement of an eligible transaction and/or with present and/or future revenue associated with that eligible transaction and the like. For example, sponsors can be selected and/or charged a premium based on their degree of interaction with a current participant and the like. Conversion information can also be obtained from, for example, sponsors and the like to facilitate in determining eligible transaction parameters.

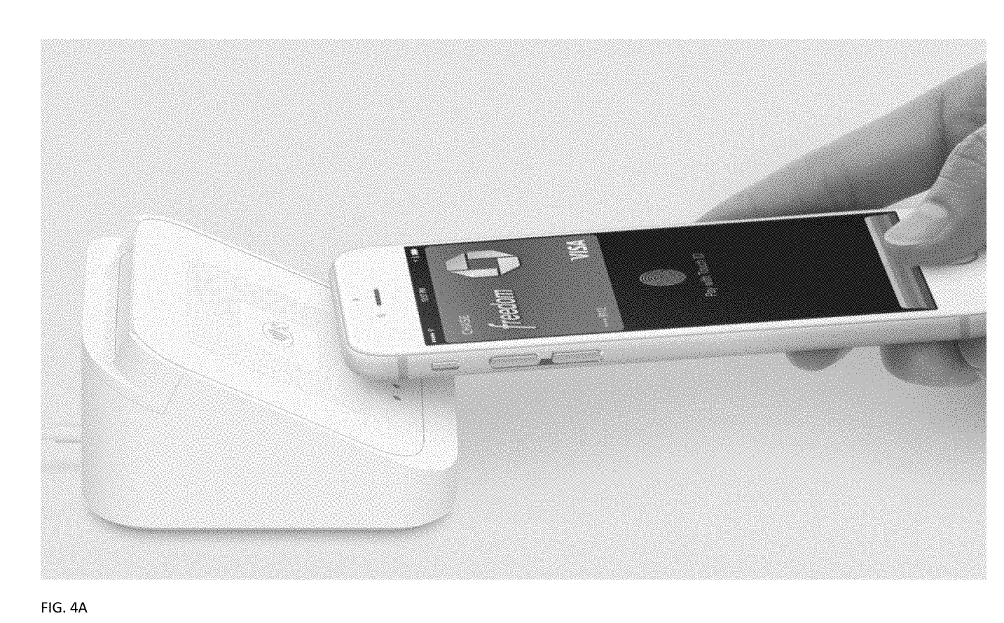

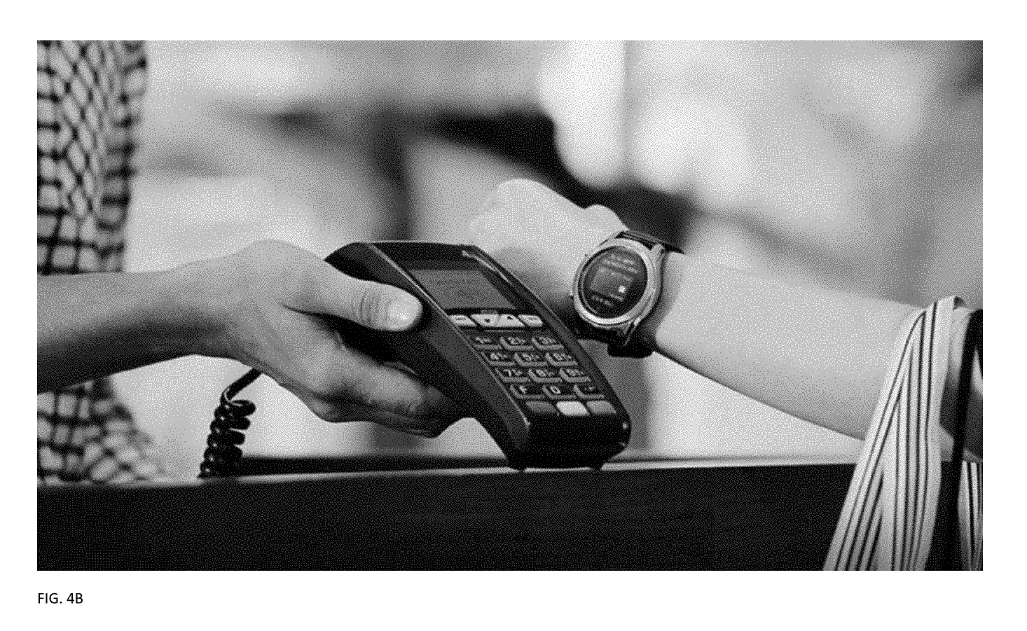

FIG. 4A shows an exemplary mobile payment system, while FIG. 4B shows an exemplary watch based payment system. In FIG. 4A, the participant can buy eligible items that result in eligible transactions using NFC electronics on the phone, and the module can receive information that a participant is engaging in, or has engaged in, one or more eligible transactions using the smart phone's near-field-communication (NFC) purchasing system. NFC is a set of short-range wireless technologies, typically requiring a distance of 4 cm or less to initiate a connection. NFC allows you to share small payloads of data between an NFC tag and a smart phone, or between two smart phone devices. Tags can range in complexity. Simple tags offer just read and write semantics, sometimes with one-time-programmable areas to make the card read-only. More complex tags offer math operations, and have cryptographic hardware to authenticate access to a sector. The most sophisticated tags contain operating environments, allowing complex interactions with code executing on the tag. The data stored in the tag can also be written in a variety of formats, but many of the smart phone framework APIs are based around a NFC Forum standard called NDEF (NFC Data Exchange Format). Smart phones with NFC simultaneously support three main modes of operation:

Reader/writer mode, allowing the NFC device to read and/or write passive NFC tags and stickers.

P2P mode, allowing the NFC device to exchange data with other NFC peers; this operation mode is used by Android Beam.

Card emulation mode, allowing the NFC device itself to act as an NFC card. The emulated NFC card can then be accessed by an external NFC reader, such as an NFC point-of-sale terminal.

The system of FIG. 4A shows the NFC usage model on a watch device. The functionality is the same as the phone functionality, except that the watch is good at tracking participant activities such as health or activity monitoring, and upon completion the watch can report to the smart phone using NFC and the data is eventually transmitted over the Internet to the server of FIG. 3 for processing.

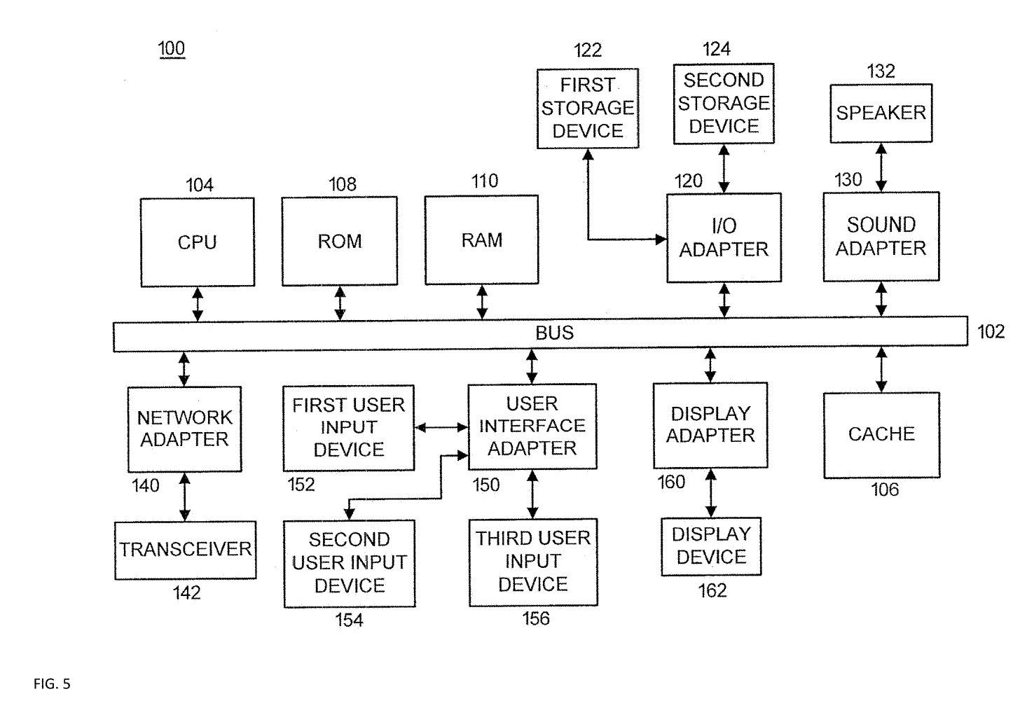

FIG. 5 shows an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a participant interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first participant input device 152, a second participant input device 154, and a third participant input device 156 are operatively coupled to system bus 102 by participant interface adapter 150. The participant input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The participant input devices 152, 154, and 156 can be the same type of participant input device or different types of participant input devices. The participant input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein. It is to be understood that both the above summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

What is claimed is:

1. A system to manage an individual's retirement, comprising:
a module to assign one or more tokens to an eligible transaction based on predetermined participant activity satisfying a sponsor's requirement;
a module to receive information on a participant engagement with the eligible transaction;
a module to assign the one or more tokens to the participant based on the eligible transaction;
a module to track and store all tokens received by the participant;
a module to redeem token values to the participant upon completion of a predefined period; and
a graphical interface for information retrieval, using a computing device, to communicate tokens receive for each eligible transaction and a current or projected token accumulation at the end of the predefined period.

2. The system of claim 1, wherein the accumulated token value is stored by a trust or a third party.

3. The system of claim 1, wherein the accumulated token value fluctuates based on a number of the participant's eligible transactions, a value assigned by the sponsor to each eligible transaction conducted by the participant, an amount of total activity of the participant and a change in value of trust assets prior to value redemption.

4. The system of claim 1, comprising a value determination module with:
TVu={Σ[Nu(VAu)]/Σ[Na(VAa)]}*AT
where, TVu is Total Value to a participant
Nu is number of the participant's eligible transactions
VAu is Value Assigned to each eligible participant transaction (average)
Na is Number of transactions by all participants
VAa is Value Assigned to all eligible transactions
A is Total Value of assets in trust

5. The system of claim 4, wherein the value determination module projects value at the end of the predefined period by adding a projected relative growth factor and a projection of total trust assets and projected token assignment relative to other users.

6. The system of claim 4, wherein if redemption occurs periodically over months or years, TVu is divided by a total number of periodic payments resulting in the amount to be paid in a current period.

7. The system of claim 1, whereby fund distributions are variable and not redeemable until a starting redemption date as determined by the sponsor.

8. The system of claim 1, wherein the tokens grow on a tax-deferred basis.

9. The system of claim 1, wherein the token is represented by points received for the transaction.

10. The system of claim 9, where the points are not deemed securities by federal securities regulators and/or where such regulator has represented in writing that it will take “no action” if a later interpretation deems the points securities.

11. The system of claim 9, where the points are determined to be securities and must therefore be registered with the appropriate regulators.

12. The system of claim 1, wherein the graphical interface reports to the participant the token value based on predetermined assumptions on usage and asset growth.

13. The system of claim 1, wherein the sponsor or a third-party commits a portion of gross revenue or net revenue to a trust for the token.

14. The system of claim 1, comprising a device to capture transaction amount, products or services purchased, vendor, or location of transaction and a mobile device in communication with the device to determine if the participant is a registered user.

15. The system of claim 1 whereby a transaction for which a token is assigned includes may types of interactions online, such as use of internet search, use of a social network, use of internet radio and other online services and mobile apps.

16. The system of claim 1, comprising a proximity detector to detect a participant's presence during a transaction and a mobile device in communication with the proximity detector to determine if the participant is a registered user.

17. The system of claim 1, comprising a magnetic code reader or a bar code reader to detect a participant's presence at a point of sale during a transaction and a mobile device in communication with the reader to determine if the participant is a registered user.

18. The system of claim 1, comprising a module to receive stored transaction information from the participant's mobile device.

19. The system of claim 1, further comprising a module for receiving additional information regarding one or more people known by the participant, wherein the module electronically sends tokens to the one or more people upon selection by the participant.

20. The system of claim 1, further comprising a multimedia device taking a picture or sample audio recording during a transaction to provide evidence that the participant engaged in the transaction.

21. The system of claim 1, comprising a sponsor module to set a type and amount of token for each transaction and wherein sponsor input comprises information regarding tokens granted vary between times of day or year and between vendor locations, between participants having different characteristics, and based on the number of participants involved, and predefined conditions triggering a token grant.

22. The system of claim 18, further comprising a participant interface displayed to a sponsor or an affiliate of sponsor or a sponsor-approved vendor, wherein the participant interface is configured for a vendor to input rules governing value provided, and receiving through the interface vendor-transmitted rules governing value provided.

23. which may include a start and end date and periodic payments between the start and the end of the predefined period.

24. A system to manage a retirement plan, comprising:
a module to assign one or more tokens to an eligible transaction based on predetermined participant activity satisfying a sponsor's requirement;
a module to receive information on a participant engagement with the eligible transaction;
a module to assign the one or more tokens to the participant based on the eligible transaction;
a module to track and store all tokens received by the participant;
a value determination module with:
TVu={Σ[Nu(VAu)]/Σ[Na(VAa)]}*AT
where, TVu is Total Value to a participant
Nu is number of the participant's eligible transactions
VAu is Value Assigned to each eligible participant transaction (average)
Na is Number of transactions by all participants
VAa is Value Assigned to all eligible transactions
A is Total Value of assets in trust
a module to redeem token values to the participant upon completion of a predefined period; and
a graphical interface for information retrieval, using a computing device, to communicate tokens receive for each eligible transaction and a current or projected token accumulation at the end of the predefined period.
